(19) United States
(12) Patent Application Publication
(10) Pub. No.: US 2024/0182655 A1
(43) Pub. Date: Jun. 6, 2024

(54) LIQUID CRYSTAL POLYMER FILM AND METHOD FOR PRODUCING LIQUID CRYSTAL POLYMER FILM

(71) Applicant: Murata Manufacturing Co., Ltd., Nagaokakyo-shi (JP)

(72) Inventors: Hiroyuki OHATA, Nagaokakyo-shi (JP); Yuya IDA, Nagaokakyo-shi (JP); Narimichi MAKINO, Nagaokakyo-shi (JP); Keita TSUBAKIMOTO, Nagaokakyo-shi (JP); Taiki ORITO, Nagaokakyo-shi (JP); Kousuke YAMAZAKI, Nagaokakyo-shi (JP); Kazuho HOSOKAWA, Nagaokakyo-shi (JP)

(21) Appl. No.: 18/442,218

(22) Filed: Feb. 15, 2024

Related U.S. Application Data
(63) Continuation of application No. PCT/JP22/32795, filed on Aug. 31, 2022.
(63) Continuation of application No. PCT/JP22/22346, filed on Jun. 1, 2022.

(30) Foreign Application Priority Data
Aug. 31, 2021 (JP) 2021-141584

(51) Int. Cl. C08J 5/18; B29B 9/12; B29B 15/08; B29C 67/08; B29K 105/00; B29K 105/12; B29K 105/16; B29K 305/10; B29K 427/18; C08K 3/34

(52) U.S. Cl. CPC C08J 5/18; B29B 15/08; B29C 67/08; C08K 3/34; B29B 9/12; B29K 2105/0079; B29K 2105/12; B29K 2105/16; B29K 2105/251; B29K 2305/10; B29K 2427/18; C08J 2329/10; C08J 2367/04; C08J 2427/18; C08J 2429/10; C08J 2471/12; C08K 2003/343

(57) ABSTRACT

A liquid crystal polymer film that includes: a liquid crystal polymer; and a filler, wherein the filler includes a flat filler, an average aspect ratio of the filler is 3 or more, and an average inclination of the filler with respect to a main surface direction of the liquid crystal polymer film is 15° or less.

### CROSS REFERENCE TO RELATED APPLICATIONS

The present application is a continuation of International application No. PCT/JP2022/032795, filed Aug. 31, 2022, which claims priority to International application No. PCT/JP2022/022346, filed Jun. 1, 2022, and to Japanese Patent Application No. 2021-141584, filed Aug. 31, 2021; and is a continuation of International application No. PCT/JP2022/022346, filed Jun. 1, 2022, which claims priority to Japanese Patent Application No. 2021-141584; the entire contents of each of which are incorporated herein by reference.

### TECHNICAL FIELD

The present invention relates to a liquid crystal polymer film and a method for producing a liquid crystal polymer film.

### BACKGROUND ART

A liquid crystal polymer (LCP) is used for a high frequency circuit board, particularly a high frequency FPC board (flexible circuit board) , because the liquid crystal polymer has a dielectric constant and a dielectric loss smaller than those of a polyimide resin, which is a conventional substrate material, and also has an extremely small water absorption coefficient and a small variation in dielectric characteristics due to water absorption. However, further improvement of high frequency characteristics is required, and for example, addition of a filler having excellent electrical characteristics has been studied.

As a method for producing an LCP film from an LCP resin, for example, a melt extrusion method and a solution casting method are known. The melt extrusion method is a method for forming an LCP film by extruding a molten LCP resin from a slit-shaped die. The solution casting method is a method in which a varnish obtained by dissolving an LCP raw material such as an LCP pellet in a solvent is applied to a copper foil and dried to form an LCP film or a flexible copper-clad laminate (FCCL).

In such a production method, molecules of the LCP resin are strongly oriented in a main surface direction of the film to form an LCP film having a linear expansion coefficient (thermal expansion coefficient: CTE) equivalent to that of copper serving as wiring. By making the CTEs of copper and the main surface direction of the LCP film equal, it is possible to prevent warpage or accumulation of distortion due to a dimensional difference between copper and the LCP resin.

Here, Patent Document 1 (Japanese Patent Application Laid-Open No. 2014-111699) describes a method of mixing a plate-like filler with a liquid crystal polymer powder and producing a filler-mixed liquid crystal polymer film by a melt extrusion method. Moreover, Patent Document 2 (Japanese Patent Application Laid-Open No. 2004-315678) describes a liquid crystal polymer resin composition containing a liquid crystalline polyester and an aprotic solvent, and a method for producing a liquid crystal polymer film composed of the resin composition by a melt casting method, and also describes that a filler may be added.
Patent Document 1: Japanese Patent Application Laid-Open No. 2014-111699
Patent Document 2: Japanese Patent Application Laid-Open No. 2004-315678

### SUMMARY OF THE INVENTION

However, when a spherical filler or the like is mixed with the LCP resin, an orientation of the LCP resin is disturbed, the CTE rises, and the FCCL is warped or distorted.

In view of the above problems, an object of the present disclosure is to provide a liquid crystal polymer film in which a linear expansion coefficient in a main surface of a liquid crystal polymer film containing a filler is controlled, and a flexible copper-clad laminate having a liquid crystal polymer film in which the linear expansion coefficient is controlled.

A liquid crystal polymer film of the present disclosure includes: a liquid crystal polymer powder; and a filler, wherein the filler includes a flat filler, an average aspect ratio of the filler is 3 or more, and an average inclination of the filler with respect to a main surface direction of the liquid crystal polymer film is 15° or less.

According to the present disclosure, it is possible to provide a liquid crystal polymer film in which a linear expansion coefficient in a main surface of a liquid crystal polymer film containing a filler is controlled, and a flexible copper-clad laminate having a liquid crystal polymer film in which a linear expansion coefficient is controlled.

### BRIEF EXPLANATION OF THE DRAWINGS

FIG. 1 is a photograph of a section of a liquid crystal polymer film in Example 1.

FIG. 2 is a photograph of a section of a liquid crystal polymer film in Example 2.

FIG. 3 is a photograph of a section of a liquid crystal polymer film in Comparative Example 1.

FIG. 4 is a photograph of a section of a liquid crystal polymer film in Comparative Example 2.

FIG. 5 is a photograph of a flexible copper-clad laminate in Example 1.

FIG. 6 is a photograph of a flexible copper-clad laminate in Comparative Example 1.

FIG. 7 is a flowchart showing a process for producing the liquid crystal polymer film of embodiments.

FIG. 8 is a flowchart showing a first modification of production steps of the liquid crystal polymer film of the embodiments.

FIG. 9 is a flowchart showing a second modification of the production steps of the liquid crystal polymer film of the embodiments.

### DETAILED DESCRIPTION OF THE INVENTION

Hereinafter, the embodiments of the present disclosure will be described, but the present disclosure is not limited thereto.

### Liquid Crystal Polymer Film

A liquid crystal polymer film (an LCP film) according to one embodiment of the present disclosure includes a liquid crystal polymer (LCP) and a filler, wherein the filler includes a flat filler, the filler has an average aspect ratio of 3 or more, and the filler has an average inclination of 15° or less with respect to a thickness direction of the LCP film.

### (Liquid Crystal Polymer)

The liquid crystal polymer is not particularly limited, and examples thereof include a thermotropic liquid crystal polymer. The thermotropic liquid crystal polymer is, for example, an aromatic polyester synthesized mainly containing a monomer such as an aromatic diol, an aromatic dicarboxylic acid, or an aromatic hydroxycarboxylic acid, and exhibits liquid crystallinity during melting.

A molecule of the liquid crystal polymer has a negative linear expansion coefficient in an axial direction of a molecular axis and a positive CTE in a radial direction of the molecular axis.

The liquid crystal polymer preferably has no amide bond. Examples of the thermotropic liquid crystal polymer having no amide bond include a copolymer of parahydroxybenzoic acid, terephthalic acid, and dihydroxybiphenyl (a block copolymer of parahydroxybenzoic acid and ethylene terephthalate) having a high melting point and a low CTE, which is called a type-1 liquid crystal polymer, and a copolymer of parahydroxybenzoic acid and 2, 6-hydroxynaphthoic acid (a block copolymer) having a melting point between a type-1 liquid crystal polymer and a type-2 liquid crystal polymer, which is called type-1.5 (or type-3).

In differential scanning calorimetry (DSC) of the LCP film, the liquid crystal polymer preferably has a temperature difference (ΔTm=Tm2−Tm1) of 10° C. or more, the temperature difference being calculated by subtracting a first melting point (Tm1) from a second melting point (Tm2) with respect to the first melting point (Tm1) of the liquid crystal polymer in the LCP film measured at a first temperature rising rate and the second melting point (Tm2) in the LCP film measured at a second temperature rising rate after the measurement of the first melting point (Tm1). When the temperature difference (ΔTm) is 10° C. or more, LCP fibers in the LCP film are sufficiently fused to each other, and furthermore, molecular chains of LCP in the LCP film are further entangled with each other, so that mechanical strength of the LCP film is further improved.

Details of a method for measuring the first melting point (Tm1) and the second melting point (Tm2) in the present embodiment will be described below.

First, in differential scanning calorimetry (DSC) of the LCP film, first, a temperature, which is at an endothermic peak appearing when the liquid crystal polymer is melted by raising the temperature from room temperature to a temperature equal to or higher than the melting point of the liquid crystal polymer at a relatively high first temperature rising rate (for example, 20° C./min), is defined as the first melting point (Tm1). At this time, in a case where a plurality of endothermic peaks is observed, the highest temperature among the respective temperatures at the plurality of endothermic peaks may be set as the first melting point (Tm1) of LCP in the LCP film. By raising the temperature of the LCP film at a relatively high temperature rising rate as described above, a change in a crystal structure of the liquid crystal polymer in the liquid crystal polymer film is suppressed. Therefore, the first melting point (Tm1) is a melting point reflecting the crystal structure of the liquid crystal polymer in the LCP film as compared with the second melting point (Tm2) measured after the measurement of the first melting point (Tm1).

Then, after the measurement of the first melting point (Tm1), a melt of the LCP film melted at a rising temperature is cooled to a temperature equal to or lower than a recrystallization temperature of the liquid crystal polymer (for example, 200° C. or lower). Then, the temperature, which is at the endothermic peak appearing when the cooled LCP film is heated to a temperature equal to or higher than the melting point of the liquid crystal polymer at the second temperature rising rate (for example, 20° C./min), is defined as the second melting point (Tm2). At this time, in a case where the plurality of endothermic peaks are observed, the highest temperature among the respective temperatures at the plurality of endothermic peaks may be set as the second melting point (Tm2) of LCP in the LCP film.

### (Liquid Crystal Polymer Powder)

The LCP film according to one embodiment of the present disclosure can be produced by a production method to be described later using liquid crystal polymer powder (LCP powder) composed of the liquid crystal polymer described above. The LCP powder contains fibrous particles made of a liquid crystal polymer (liquid crystal polymer fibers: LCP fibers).

The LCP fibers contained in the LCP powder are not particularly limited as long as they contain a fibrous portion. The fibrous portion may be linear or may have branching or the like.

An average diameter of the LCP fibers is 2 μm or less, preferably 1.4 μm or less, and more preferably 1 μm or less. The average diameter of the LCP fibers is, for example, 0.07 μm or more. The smaller the average diameter of the LCP fibers, the less a riding between the LCP fibers during production of the LCP film. As a result, this facilitates an in-plane orientation of the LCP during production of the LCP film, thereby reducing the linear expansion coefficient (CTE) in the main surface of the LCP film and amount of warpage of the flexible copper-clad laminate (FCCL). Moreover, the average aspect ratio of the LCP fibers is preferably 10 to 500, and more preferably 10 to 300.

Note that, the average diameter and average aspect ratio of the LCP fibers are measured by the following method.

The LCP powder composed of the LCP fibers to be measured is dispersed in ethanol to prepare a slurry in which 0.01 mass % of the LCP powder is dispersed. At this time, the slurry was prepared so that a moisture content in the slurry was 1 mass % or less. Then, 5 μL to 10 μL or less of this slurry was dropped onto a slide glass, and then the slurry on the slide glass was naturally dried. The LCP powder is disposed on the slide glass by naturally drying the slurry.

Next, a predetermined region of the LCP powder disposed on the slide glass is observed with a scanning electron microscope (SEM) to collect 100 or more pieces of image data of the particles (the LCP fibers) constituting the LCP powder. Note that, in the collection of the image data, the region was set according to the size per particle of the LCP so that the number of image data was 100 or more. Moreover, for each particle of the LCP, the image data was collected by appropriately changing a magnification of the SEM to 500 times, 3,000 times, or 10,000 times in order to suppress leakage of the collection of the image data and occurrence of a measurement error.

Next, a longitudinal direction dimension and a width direction dimension of each of the LCP fibers are measured using the collected image data.

In one of the LCP fibers photographed in each piece of the image data, a direction of a straight line connecting both ends of a longest path in a path from one end portion to an end portion opposite to the one end portion through substantially a center of the particle is defined as a longitudinal direction. Then, a length of a straight line connecting both ends of the longest path is measured as the longitudinal direction dimension.

Moreover, a particle dimension of one particle of the LCP powder in a direction orthogonal to the longitudinal direction was measured at three different points in the longitudinal direction. An average value of the dimensions measured at these three points was taken as the width direction dimension (fiber diameter) per particle of the LCP powder.

Furthermore, a ratio of the longitudinal direction dimension to the fiber diameter [longitudinal dimension/fiber diameter] is calculated and taken as the aspect ratio of the LCP fibers.

Then, the average value of the fiber diameters measured for 100 LCP fibers is taken as the average diameter.

Moreover, the average value of the aspect ratios measured for 100 LCP fibers is taken as the average aspect ratio.

Note that, the fibrous particles may be contained in the LCP powder as an aggregate in which the fibrous particles are aggregated.

Moreover, in the fibrous particles, the axial direction of the LCP molecules constituting the fibrous particles and the longitudinal direction of the fibrous particles tend to coincide with each other. Note that, it is considered that this is because, in a case where the LCP powder is produced, the axial direction of the LCP molecules is oriented along the longitudinal direction of the fibrous particles due to breakage between a plurality of domains formed by bundling the LCP molecules.

In the LCP powder, a content (a number ratio) of particles other than the fibrous particles (massive particles that are not substantially fibrous) is preferably 20% or less. For example, when the LCP powder is placed on a plane, particles having a maximum height of 10 μm or less are fibrous particles, and particles having a maximum height of more than 10 μm are massive particles.

The LCP powder preferably has a D50 (an average particle size) value of 13 μm or less as measured by particle size measurement using a particle size distribution measuring device by a laser diffraction scattering method.

The surface of the LCP powder may be previously subjected to ultraviolet treatment (UV treatment). The surface treatment of the LCP powder in advance increases the number of oxygen atoms located on the surface of the LCP powder. When the number of oxygen atoms located on the surface of the LCP powder increases, an intermolecular force between the molecules constituting the surface of the LCP powder and the molecules constituting the surface of the filler in the LCP film increases. As a result, this improves interfacial adhesion between the LCP powder and the filler. Thus, the strength of the LCP film is improved.

### (Filler)

The filler of the present disclosure includes a flat filler, and may include a filler having a shape other than the flat shape. Moreover, the “flat filler” in the present disclosure includes a filler obtained by heating and compressing a filler (hereinafter, sometimes referred to as a “filler raw material”) used as a raw material, a filler raw material that is flat, a filler obtained by aggregating filler raw materials such as spherical filler raw materials to form flat aggregates, and the like.

The filler raw material is not particularly limited, and any of an organic filler and an inorganic filler can be used. Examples of the organic filler include perfluoroalkoxy fluorine (PFA) resin, polytetrafluoroethylene (PTFE), polyphenylene ether (PPE), polyimide, polyamideimide, polyetherimide, polyethersulfone, cyclic polyolefin, syndiotactic polystyrene, and polyphenylene sulfide. As the inorganic filler, for example, powder of an inorganic oxide such as talc, alumina, or silica, carbon powder, ceramic powder, glass powder, or the like can be used.

Properties of the filler raw material, for example, necessary properties such as the dielectric constant and thermal conductivity are imparted to the LCP film. The filler raw material is preferably an organic filler from a viewpoint of flexibility of the LCP film. As the organic filler, a PFA resin, a PTFE, or a PPE is preferably used. The filler raw materials may be used singly or in combination of two or more kinds thereof.

A shape of the filler raw material is not particularly limited, and an amorphous filler, a plate-like filler, a granular filler, or the like can be used.

The filler raw material has a D50 (the average particle size) value of 5 μm or less, preferably 3 μm or less, and more preferably 1 μm or less as measured by particle size measurement using a particle size distribution measuring device by the laser diffraction scattering method.

Moreover, the average particle diameter of the filler raw material is preferably smaller than the average diameter of the LCP fibers. When the filler is mixed with the LCP, the orientation of the LCP fibers is disturbed, but in this way, disturbance of the orientation of the LCP fibers can be suppressed.

Note that, the filler raw material may be surface-treated by plasma treatment. The plasma treatment is, for example, in-liquid plasma treatment. In the in-liquid plasma treatment, first, an ethanol slurry is obtained by mixing a filler raw material and a 50 mass % ethanol aqueous solution. A gas is bubbled in the ethanol slurry. Discharge is performed in the bubbled gas. By this discharge, plasma gas is generated, and the surface of the filler raw material can be treated. As a result, a chemical bond of the molecule on a surface of the filler atom is broken, and a predetermined functional group is generated according to the kind of the filler raw material. In a case where the filler raw material is, for example, the PFA resin, carboxyl groups are generated on the surface. When carboxyl groups are generated on the surface, the intermolecular force due to hydrogen bonding between molecules constituting the surface of the LCP powder and molecules constituting the surface of the filler in the LCP film increases. As a result, this improves the interfacial adhesion between the LCP powder and the filler. Thus, the strength of the LCP film is improved. The gas is, for example, nitrogen.

The filler in the present disclosure also includes a filler having an average aspect ratio of 3 or more and a flat shape such as a sheet shape, a phosphorus piece shape, or a flake shape. Here, the average aspect ratio of the filler is an average value of aspect ratios calculated by measuring a major axis and a minor axis of a plurality of fillers by a method to be described later. The major axis represents a diameter of the filler in the longest direction, and the minor axis represents the longest length in a direction perpendicular to the major axis. The aspect ratio of each filler is a ratio of the major axis to the minor axis. In a case where the average aspect ratio of the filler is less than 3, the CTE in the main surface of the LCP film cannot be reduced because the LCP molecules are oriented in the thickness direction of the LCP film. The average aspect ratio of the filler is preferably 4 or more.

Moreover, the average inclination of the filler with respect to the main surface direction of the LCP film is within 15°. In a case where the average inclination of the filler with respect to the main surface direction of the LCP film exceeds 15°, the CTE in the main surface of the LCP film cannot be reduced because the LCP molecules are oriented in the thickness direction of the LCP film. The average inclination of the filler with respect to the main surface direction of the LCP film is preferably 10° or less.

The average aspect ratio of the filler and the average inclination with respect to the thickness direction of the LCP film are determined by hardening a periphery of an arbitrary section of the LCP film or the FCCL containing the filler to be measured with a resin, polishing the film, photographing the polished section with the SEM, and analyzing the photographed image.

The filler and the LCP powder can be identified by binarizing the SEM image using image processing software (“ImageJ”) as image analysis software. Here, binarization processing refers to processing of converting a density of each pixel into two values of 1 and 0 with a constant reference value (a threshold).

Specifically, the binarization processing for recognizing the filler is performed on the SEM image using image processing software (“ImageJ”) to obtain a binarized image. Here, the binarization processing is performed, for example, based on brightness of the pixel. Although there is no clear value in a threshold value of the brightness in the binarization processing, it is preferable to prepare the threshold value so that the ratio of a bright portion to a dark portion matches an actual volume mixing ratio of the filler and the LCP powder.

Based on the binarized image, the major axis, minor axis, and the inclination with respect to the thickness direction of the LCP film of the plurality of fillers in the microscopic image are calculated. Here, the number of fillers to be measured is at least 50 or more, and preferably 100 or more. Moreover, it is preferable to perform image analysis in a plurality of fields of view in the same LCP film or FCCL, but in a case where the image analysis is performed in a single field of view, the image analysis of 50 or more fillers may be performed as described above, and the average value thereof may be used as the average aspect ratio and the average inclination with respect to the thickness direction of the LCP film. In the present disclosure, values measured for 50 or more fillers are taken as the average aspect ratio and the average inclination. The field of view may be, for example, 50 μm long by 100 μm wide. Note that, a filler having an aspect ratio of the major axis to the minor axis of 1.1 or less is regarded as a true sphere, and the aspect ratio is set to 1 and the inclination is set to 45°.

Regarding the average aspect ratio of the filler, first, an area of each filler is measured by the following Formula (1).

Area (μm²)=radius of major axis (μm)×radius of minor axis (μm)×circular constant Formula (1)

Next, an average of the areas measured for 50 or more fillers is taken as the average area, and an area average ratio of each filler is determined by the following Formula (2).

Area average ratio=area (μm²)÷average area (μm²) Formula (2)

Then, the larger the sectional area of the filler, the greater the influence on the orientation of many LCP fibers and the influence on the CTE, and thus a corrected aspect ratio of the filler is obtained by the following Formula (3).

Corrected aspect ratio=actually measured aspect ratio×area average ratio Formula (3)

In the present disclosure, the average of the corrected aspect ratios is taken as the average aspect ratio.

Moreover, the larger the sectional area of the filler, the greater the influence on the orientation of many LCP fibers and the influence on the CTE, and thus the correction inclination of the filler is obtained by the following Formula (4).

Corrected inclination (°)=measured inclination (°)×area average ratio Formula (4)

In the present disclosure, an average of the corrected inclination is taken as the average inclination.

### Method for Producing Liquid Crystal Polymer Film

Hereinafter, each step of the manufacturing method of the present embodiment will be described.

As shown in FIG. 7, the method for producing a liquid crystal polymer film according to the present embodiment includes a dispersing step (S1), a matting step (S2), a heat pressing step (S3), and a metal foil removing step (S4).

First, a method for producing the LCP powder used in the dispersing step (S1) will be described in detail. The LCP powder can be prepared, for example, by performing the following coarse pulverizing step, fine pulverizing step, coarse particle removing step, and fiberizing step in this order.

Examples of the shape of a LCP-containing raw material (a LCP raw material) used for producing the LCP powder include uniaxially oriented pellets, biaxially oriented films, and powdery LCP. The LCP constituting the LCP raw material is similar to the LCP constituting the LCP fibers described above.

### (Coarse Pulverizing Step)

In the coarse pulverizing step, the LCP raw material is coarsely pulverized. For example, the LCP raw material is coarsely pulverized with a cutter mill. A size of the particles of the coarsely pulverized LCP is not particularly limited as long as the particles can be used as a raw material in the fine pulverizing step described later. A maximum particle size of the coarsely pulverized LCP is, for example, 3 mm or less.

Note that, the coarse pulverizing step is not necessarily performed. For example, if the LCP raw material can be used as a raw material in the fine pulverizing step, the LCP raw material may be directly used as a raw material in the fine pulverizing step.

### (Fine Pulverizing Step)

In the fine pulverizing step, the LCP raw material (after the coarse pulverizing step) is pulverized in a state of being dispersed in liquid nitrogen to obtain a granular finely pulverized liquid crystal polymer (finely pulverized LCP).

In the fine pulverizing step, it is preferable that the LCP raw material which is dispersed in the liquid nitrogen is pulverized using a medium. The medium is, for example, a bead. In the fine pulverizing step of the present embodiment, it is preferable to use a bead mill having relatively few technical problems from a viewpoint of handling liquid nitrogen. Examples of the apparatus that can be used in the fine pulverizing step include “LNM-08” which is a liquid nitrogen bead mill manufactured by AIMEX CO., LTD.

The granular finely pulverized LCP obtained by the fine pulverizing step preferably has a D50 of 50 μm or less as measured by a particle size distribution measuring device by a laser diffraction scattering method. As a result, this makes it possible to suppress clogging of the granular finely pulverized LCP with a nozzle in the following fiberizing step.

### (Coarse Particle Removing Step)

Next, in the coarse particle removing step, coarse particles are removed from the granular finely pulverized LCP obtained in the fine pulverizing step. For example, the granular finely pulverized LCP is sieved with a mesh to obtain the granular finely pulverized LCP under the sieve, and the coarse particles contained in the granular finely pulverized LCP can be removed by removing the granular LCP on the sieve. A type of mesh may be appropriately selected, and examples of the mesh include a mesh having an opening of 53 μm. Note that, the coarse particle removing step is not necessarily performed.

### (Fiberizing Step)

Next, in the fiberizing step, the granular LCP is crushed by a wet high-pressure crushing device to obtain LCP powder. In the fiberizing step, first, the finely pulverized LCP is dispersed in a dispersion medium for the fiberizing step. In the finely pulverized LCP to be dispersed, the coarse particles may not be removed, but it is preferable that the coarse particles are removed. Examples of the dispersion medium for the fiberizing step include water, ethanol, methanol, isopropyl alcohol, toluene, benzene, xylene, phenol, acetone, methyl ethyl ketone, diethyl ether, dimethyl ether, hexane, and mixtures thereof.

Then, the finely pulverized LCP in a state of being dispersed in the dispersion medium for the fiberizing step, that is, the paste-like or the slurry-like finely pulverized LCP is passed through the nozzle in a state of being pressurized at high pressure. By passing through the nozzle at a high pressure, a shearing force or collision energy due to a high-speed flow in the nozzle acts on the LCP, and the granular finely pulverized LCP is crushed, so that the fiberization of the LCP proceeds and LCP powder consisting of fine LCP fibers can be obtained. The pressure during pressurization is, for example, 100 MPa to 300 MPa. A nozzle diameter of the nozzle is preferably as small as possible within a range in which clogging of the finely pulverized LCP does not occur in the nozzle from a viewpoint of applying high shear force or high collision energy. Since the granular finely pulverized LCP has a relatively small particle size, the nozzle diameter in the wet high-pressure crushing device used in the fiberizing step can be reduced. The nozzle diameter is, for example, 0.2 mm or less.

Note that, as described above, a plurality of fine cracks are formed in the granular finely pulverized LCP. Therefore, the dispersion medium enters into the finely pulverized LCP through fine cracks by pressurization in a wet high-pressure crushing device. Then, when the paste-like or the slurry-like finely pulverized LCP passes through the nozzle and is positioned under normal pressure, the dispersion medium that has entered the finely pulverized LCP expands in a short time. When the dispersion medium that has entered the finely pulverized LCP expands, destruction progresses from inside of the finely pulverized LCP. Therefore, the fiberization proceeds to the inside of the finely pulverized LCP, and the molecules of the LCP are separated into domain units arranged in one direction. As described above, in the fiberizing step according to the present embodiment, by defiberizing the granular finely pulverized LCP obtained in the fine pulverizing step in the present embodiment, it is possible to obtain the LCP powder which has a low content of massive particles and consists of fine LCP fibers as compared with the LCP powder obtained by crushing the granular LCP obtained by a conventional freeze pulverizing method.

Note that, in the fiberizing step in the present embodiment, the finely pulverized LCP may be pulverized by the wet high-pressure crushing device a plurality of times to obtain the LCP powder, but from a viewpoint of production efficiency, the number of times of crushing by the wet high-pressure crushing device is preferably small, and is, for example, 5 times or less. Moreover, from a viewpoint of obtaining the LCP powder having a smaller average diameter, the number of times of crushing by wet high-pressure crushing is preferably large, and is, for example, 6 times to 90 times.

### (UV Treating Step)

A method for producing the LCP powder according to the present embodiment may further include a UV treating step. In the UV treating step, the surface of the LCP powder obtained in the fiberizing step is treated with ultraviolet rays. Specifically, the LCP powder obtained in the fiberizing step is subjected to a wet UV treatment. An ultraviolet ray treatment time is, for example, 1 hour to 5 hours.

### (Dispersing Step: S1)

In the dispersing step, which is a first step of the method for producing the LCP film, the LCP powder and the filler raw material are dispersed in the dispersion medium to form a paste or slurry. As described above, in the present embodiment, since the fine fibrous LCP powder and the filler raw material having a small average particle diameter are used, the LCP powder and the filler raw material can be dispersed in a dispersion medium having a high viscosity. Thus, a homogeneous LCP film can be produced.

Examples of the dispersion medium used in the dispersing step include butanediol, water, ethanol, terpineol, and a mixture of water and ethanol. For example, in a case where butanediol is used as the dispersion medium, a mixture of a paste-like LCP powder and a filler is obtained. In a case where a mixture of water and ethanol is used as the dispersion medium, a mixture of the slurry-like LCP powder and the filler is obtained.

A mixing ratio of the LCP powder and the filler raw material may be, for example, from 5:5 to 8:2 by volume. If a volume ratio of the filler raw material is larger than that of the LCP powder, since the filler is a main component in the mixture, it is difficult to form a film from the mixture. Moreover, it is more preferable that the LCP powder and the filler raw material are mixed at a volume ratio of 5:5 to 7:3. In other words, in the liquid crystal polymer film, a content ratio of the filler to total content of the liquid crystal polymer and the filler is more preferably 30 vol % to 50 vol %. When the content ratio of the filler is 30 vol % to 50 vol %, it is easy to achieve both a desired electrical property improving effect by the filler and molding of the LCP film.

### (Matting Step: S2)

Next, in the matting step, a mixture of the paste-like or the slurry-like LCP powder and the filler is dried to form a liquid crystal polymer fiber mat (an LCP fiber mat). In one embodiment of the present invention, the matting step includes, for example, an applying step and a drying step.

In the applying step, a mixture of the paste-like LCP powder and the filler is applied to a metal foil such as a copper foil. In the applying step, the mixture of the paste-like LCP powder and the filler is applied onto a metal foil such as a copper foil as described above, but instead of the metal foil, a composite sheet or the like composed of a reinforcing material such as a polyimide film, a PTFE film, or a glass fiber woven fabric, and a heat-resistant resin which hardly adheres to LCP may be used. As a result, this makes it easy to industrially produce an LCP film.

Next, in the drying step, the mixture of the paste-like LCP powder and the filler applied to the copper foil is heated and dried to vaporize the dispersion medium. By the above heating and drying, the LCP fiber mat is formed on the metal foil such as a copper foil.

Moreover, in the drying step, since the dispersion medium is gradually removed from the mixture of the paste-like LCP powder and the filler, a total thickness of the mixture of the paste-like LCP powder and the filler gradually decreases during drying. Therefore, a thickness of the LCP fiber mat is thin compared to a total thickness of the mixture of the paste-like LCP powder and the filler formed on the copper foil.

Furthermore, as the total thickness of the mixture of the paste-like LCP powder and the filler gradually decreases during drying, a longitudinal direction of the fibrous particles in the LCP powder changes. Specifically, among the fibrous particles, the fibrous particles having the longitudinal direction in the entire thickness direction of the mixture of the paste-like LCP powder and the filler are inclined such that the longitudinal direction is directed toward inside of the main surface of the copper foil. Therefore, there is anisotropy in the longitudinal direction of the fibrous particles in the formed LCP fiber mat.

In the matting step, the dispersion medium may be vaporized by further applying a mixture of the paste-like LCP powder and the filler onto the LCP fiber mat formed on the metal foil in the drying step, and then drying the applied mixture. As described above, the matting step may include the applying step and the drying step repeatedly in this order. As a result, an LCP fiber mat having a desired basis weight can be obtained. Moreover, in a case where the applying step and the drying step are repeatedly performed, a mixture in which the mixing ratio of the LCP powder and the filler is changed for each applying step may be used. As a result, this makes it possible to obtain the LCP fiber mat capable of forming the LCP film having desired properties.

In the matting step in the present embodiment, a mixture of the slurry-like LCP powder and the filler may be formed into the LCP fiber mat by a papermaking method instead of the applying step and the drying step. According to the papermaking method, it is not necessary to use a special dispersion medium used in the applying step, for example, expensive terpineol. Moreover, in the papermaking method, the dispersion medium used in the dispersing step can be recovered and reused easily. As described above, the LCP film can be produced at low cost by the papermaking method.

In the matting step using the papermaking method, specifically, first, a slurry-like LCP powder and a filler are paper-made on a mesh, a nonwoven fabric-like microporous sheet, or a woven fabric. Then, the mixture of the slurry-like LCP powder and the filler disposed on the mesh is heated and dried to obtain the LCP fiber mat.

### (Heat Pressing Step: S3)

Next, in the heat pressing step, the LCP fiber mat is heat-pressed to obtain the LCP film. Moreover, by heat-pressing the LCP fiber mat, the filler raw material or the aggregate of the filler raw material becomes flat, and the filler is oriented so as to have an inclination of 15° or less with respect to the main surface direction of the LCP film. Specifically, in the heat pressing step, the LCP fiber mat is heat-pressed together with the copper foil. As a result, the heat pressing step also serves as a step of bonding the LCP film and the copper foil to each other, so that the LCP film to which the copper foil is bonded can be obtained at low cost. Note that, in the case where the LCP fiber mat is heated for a long time in the heat pressing step, it is preferable that the LCP fiber mat is heated and pressed in a vacuum.

Heating in the heat pressing step is performed to bond the LCP fibers to each other. However, in order to easily make the filler raw material or the aggregate of the filler raw material flat, in a case where the average particle size of the filler raw material exceeds 1 μm, it is preferable to heat-press the filler raw material in a range of ±10° C. of the melting point of the filler raw material. Note that, in a case where the average particle size of the filler raw material is 1 μm or less, the orientation of the LCP fibers is hardly disturbed, and therefore a heating temperature is not limited. However, in a case where the LCP fibers are surface-treated with ultraviolet rays and in a case where the filler raw material is plasma-treated, from a viewpoint of bonding the LCP fibers and the filler raw material to each other at an interface between the LCP fibers and the filler raw material, the heating temperature in the heat pressing step is preferably equal to or lower than the melting point of the LCP fiber.

The pressure in the heat pressing step is preferably 3 MPa or more, more preferably 5 MPa or more in order that the filler raw material becomes flat and the filler is oriented so as to have an inclination of 15° or less with respect to the main surface direction of the LCP film. Note that, when the pressure is excessively increased, the LCP resin melts and flows, and thus the pressure is preferably 10 MPa or less.

Holding time in the heat pressing step is not particularly limited, and may be, for example, 5 seconds or more, or 10 seconds or more. Moreover, since the filler raw material becomes flatter by being held for a long time, for example, the time may be 3 minutes or longer, and may be 5 minutes or longer.

Moreover, in the heat pressing step, a polyimide film, a PTFE film, or a composite sheet including a reinforcing material such as a glass fiber fabric and a heat-resistant resin which hardly adheres to LCP may be interposed as a release film between a pressing machine to be used in the heat pressing step and the LCP fiber mat.

Moreover, in place of the polyimide film, an additional copper foil may be interposed between the pressing machine and the LCP fiber mat. In this case, the LCP film in which copper foils are bonded to both surfaces can be obtained. The LCP film in which the copper foils are bonded to both surfaces can be used as a double-sided copper foil FCCL.

An outer dimension of the LCP film molded by the heat pressing step as viewed from the thickness direction, that is, a planar dimension along a film surface is substantially the same as that of the LCP fiber mat before heat-pressing. Then, among the fibrous particles of the LCP powder in the LCP fiber mat, the fibrous particles having the longitudinal direction along the thickness direction of the LCP fiber mat are heated while being pushed down in the direction of the inside of the main surface of the copper foil by the heat-pressing. The LCP constituting the LCP powder has the axial direction of the molecules in the longitudinal direction of the fibrous particles, and thus the axial direction of the molecule of LCP is also pushed down in the direction of the inside of the main surface of the copper foil. Therefore, except for the molecules constituting the massive particles, the axial direction of each of the molecules constituting the LCP is oriented along a direction inside the main surface of the LCP film over the thickness direction of the LCP film. Therefore, in the molded LCP film, the main orientation direction of the molecule of LCP tends to be along the direction inside the main surface of the copper foil, that is, the main surface inner direction of the LCP film.

Similarly, the filler is heated while being pushed down toward the inside of the main surface of the copper foil by the heat-pressing. Therefore, in the filler, the major axis thereof is oriented along the direction inside the main surface of the LCP film over the thickness direction of the LCP film.

Accordingly, it is considered that the CTE inside the main surface is reduced in the LCP film of the present embodiment.

Moreover, in a case where the copper foil is bonded to the LCP film, the CTE of the LCP film can be reduced to the same extent as the CTE of the copper foil (about 18 to 20 ppm/° C.). As a result, defects such as warpage due to thermal shrinkage can be suppressed in the LCP film to which the copper foil is bonded.

### (Metal Foil Removing Step: S4)

Finally, the metal foil bonded to the LCP film may be removed by etching or the like as necessary. As a result, a single LCP film to which the metal foil is not bonded is obtained.

Note that, the method for producing a liquid crystal polymer film according to the present embodiment may further include other steps.

### (Heat Treating Step: S5)

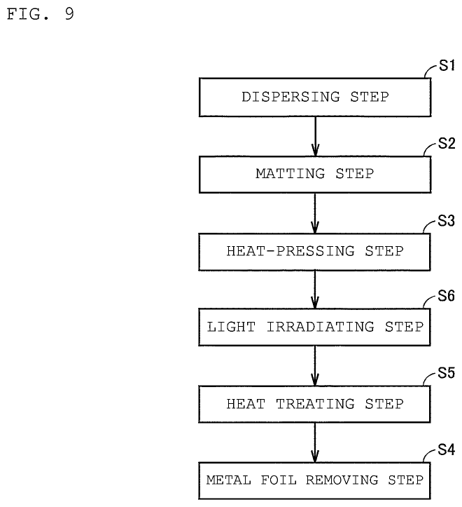

FIG. 8 is a flowchart showing the first modification of the production steps of the liquid crystal polymer film of the embodiment. As shown in FIG. 8, the method for producing a liquid crystal polymer film according to the present embodiment may further include the heat treating step (S5) after the heat pressing step (S3). The heat treating step (S5) may be performed before the metal foil removing step (S4) as shown in FIG. 8, or may be performed after the metal foil removing step (S4).

In the heat treating step (S5), the LCP film obtained in the heat pressing step or the FCCL obtained in the metal foil removing step is heated in a heating furnace such as a hot air circulating furnace. The heat treatment can be performed by a known means such as a heat roll or an infrared heater in addition to the hot air circulating furnace. In the heat treating step (S5), the LCP is not pressurized as in the heat pressing step (S3). Therefore, there is little concern that the LCP flows largely in an environment of a relatively high temperature close to a melting point of the LCP. Thus, a thickness change of the LCP film and generation of a fragile layer in the LCP film due to an interface shear stress can be suppressed.

The heating temperature in the heat treating step (S5) is preferably not less than a temperature lower than the melting point of the LCP powder by 30° C. and not more than a temperature higher than the melting point of the LCP by 10° C. (note that, in the present description, in a case where “the melting point of LCP” is simply referred to, “the melting point of LCP” means the melting point of the LCP powder, that is, the melting point of the LCP raw material, and “the melting point of LCP” is the second melting point (Tm2)). By heat-treating the LCP film (in the FCCL, a resin layer formed of the LCP film in close contact to the copper foil) at a temperature lower than the melting point of LCP by 30° C. or more, heat fusion between the LCP fibers or between the LCPs proceeds, and the mechanical strength of the LCP film is further improved. Furthermore, by performing the heat treatment at a temperature lower than the melting point of LCP by 30° C. or higher, the crystal structure of LCP in the LCP film changes, and the molecular chains of LCP are further entangled with each other, thereby improving the mechanical strength of the LCP film. Note that, in a case where the filler raw material is an organic filler, the mechanical strength of the LCP film may be improved by the progress of heat fusion between the fillers by the heat treatment.

Moreover, when the heating temperature is equal to or lower than a temperature higher than the melting point of LCP by 10° C., flow of the LCP fibers and the filler raw material is suppressed, and an increase in the linear expansion coefficient in the direction inside the main surface of the LCP film can be suppressed.

Heating time in the heat treating step (S5) is not particularly limited, and may be, for example, 1 second or more, or 10 seconds or more. Moreover, since a variation in the crystal structure of LCP in the LCP film is reduced by holding for a long time, the heating time may be, for example, 10 minutes or more, or 60 minutes or more.

A heating atmosphere in the heat treating step (S5) is preferably an inert gas atmosphere such as nitrogen or argon or a vacuum atmosphere. An oxygen concentration in the heated atmosphere is preferably 10,000 ppm or less, and more preferably 1000 ppm or less.

### (Light Irradiating Step: S6)

FIG. 9 is the flowchart showing the second modification of the production steps of the liquid crystal polymer film of the embodiment. As shown in FIG. 9, the method for producing a liquid crystal polymer film according to the present embodiment may further include a light irradiating step (S6) after the heat pressing step (S3). The light irradiating step (S6) may be performed before the heat treating step (S6) and the metal foil removing step (S4) as shown in FIG. 9, or may be performed immediately after the heat treating step (S5) or the metal foil removing step (S4).

As a light irradiation device in the light irradiating step (S6), for example, a flash lamp can be adopted. Specific examples of the light irradiation device include (PulseForge (registered trademark) 1300 manufactured by NovaCentrix).

### EXAMPLES

Hereinafter, the present invention will be described in more detail with reference to the examples, but the present invention is not limited thereto.

### Example 1

### (Producing Liquid Crystal Polymer Powder)

In Example 1, first, uniaxially oriented pellets of LCP (cylindrical pellet having a diameter of 3 to 4 mm, melting point: 315° C.) were prepared as the LCP raw material. The material of LCP is a block copolymer of parahydroxybenzoic acid and 4,6-hydroxynaphthoic acid.

This LCP raw material was coarsely pulverized by a cutter mill (MF10, manufactured by IKA). The coarsely pulverized LCP was passed through a mesh having a diameter of 3 mm provided at a discharge port of the cutter mill to obtain a coarsely pulverized LCP.

Next, the coarsely pulverized LCP was finely pulverized with a liquid nitrogen bead mill (LNM-08 manufactured by AIMEX CORPORATION, vessel capacity: 0.8 L). Specifically, 500 mL of media and 30 g of coarsely pulverized LCP were put into a vessel, and pulverization treatment was performed at a rotation speed of 2000 rpm for 120 minutes. As the medium, beads made of zirconia (ZrO₂) having a diameter of 5 mm were used. Note that, in the liquid nitrogen bead mill, wet pulverizing treatment is performed in a state in which the coarsely pulverized LCP is dispersed in the liquid nitrogen. As described above, by pulverizing the coarsely pulverized LCP with the liquid nitrogen bead mill, granular finely pulverized LCP was obtained.

The particle size of the finely pulverized LCP was measured. The finely pulverized LCP dispersed in the dispersion medium was subjected to ultrasonic treatment for 10 seconds, and then set in a particle size distribution measuring device (LA-950 manufactured by HORIBA Ltd.) by a laser diffraction scattering method to measure the particle size. Note that, as the dispersion medium, Ekinen (registered trademark, Japan Alcohol Sales Co., Ltd.) which was a mixed solvent containing ethanol as a main agent was used. A measured value of D50 for the finely pulverized LCP was 23 μm.

Next, a dispersion liquid obtained by dispersing the finely pulverized LCP in Ekinen was sieved with a mesh having an opening of 100 μm to remove the coarse particles contained in the finely pulverized LCP, and finely pulverized LCP passing through the mesh was recovered. A yield of the finely pulverized LCP by the removal of coarse particles was 85% by mass.

Next, the finely pulverized LCP from which the coarse particles were removed was dispersed in a 20 mass % ethanol aqueous solution. An ethanol slurry in which the finely pulverized LCP was dispersed was repeatedly crushed five times using a wet high-pressure crushing device under conditions with a nozzle diameter of 0.2 mm and a pressure of 200 MPa to be formed into fibers. As the wet high-pressure crushing device, a high-pressure crushing device (Nanoveta manufactured by Yoshida Kikai Kogyo Co., Ltd.) was used. The ethanol slurry in which the finely pulverized LCP was dispersed was dried with a spray dryer to obtain the LCP powder. An average fiber diameter measured for 100 LCP fibers contained in the LCP powder was 0.8 μm.

### (Producing Liquid Crystal Polymer Film)

As the filler raw material, a perfluoroalkoxy fluorine resin (the PFA resin) (amorphous, average particle size: 2 μm, melting point: 300° C.) was prepared.

The PFA resin and the LCP powder obtained above were dispersed in butanediol as the dispersion medium to form a paste. The mixing ratio of the PFA resin and the LCP powder was 3:7 in terms of the volume ratio.

Next, a paste-like mixture was applied onto a roughened surface of an electrolytic copper foil (FWJ-WS-12 manufactured by Furukawa Electric Co., Ltd.) having a 180 mm square and a thickness of 12 μm using a 160 mm square metal plate. Then, the electrolytic copper foil coated with the paste-like mixture was heated to 180° C. on a hot plate to vaporize butanediol as the dispersion medium, and the paste-like mixture on the electrolytic copper foil was dried. In this way, a thin LCP fiber mat was thus formed on the electrolytic copper foil.

The paste-like mixture was further applied onto the thin LCP fiber mat. The applied paste-like mixture was dried in the same manner as when the previously applied paste-like mixture was dried. As described above, the application and drying were repeated a plurality of times to mold the LCP fiber mat adjusted so that the basis weight was 35 g/m² on the electrolytic copper foil.

Next, the LCP fiber mat formed on the electrolytic copper foil was heat-pressed together with the electrolytic copper foil using a high-temperature pressing device. Specifically, first, the release film was stacked on an opposite side to an electrolytic copper foil side of the LCP fiber mat molded on the electrolytic copper foil. As the release film, a polyimide film (Kapton (registered trademark) 100H manufactured by DU PONT-TORAY CO., LTD.) was used. Then, the LCP fiber mat on which the release film was laminated was set in the high-temperature pressing device. The set LCP fiber mat was pressed together with the release film and the electrolytic copper foil for 10 seconds at a temperature of 295° C. and a pressing pressure of 6 MPa. Note that, a size of the pressing member used for pressing was 170 mm square. After completion of the heat-pressing, the release film was removed to obtain the FCCL.

Finally, the electrolytic copper foil bonded to the LCP film was removed by etching using an aqueous solution of ferric chloride. As a result, an LCP film was obtained. A thickness of the LCP film was 25 μm.

### Example 2

In Example 2, a PFA resin which was a filler raw material similar to that in Example 1 was used, but the PFA resin was refined by repeatedly crushing the PFA resin 20 times under the conditions with a nozzle diameter of 0.18 mm and a pressure of 200 MPa using a wet high-pressure crushing device (Star Bar Strabo manufactured by Sugino Machine Limited). Moreover, the FCCL and the LCP film were produced in the same production steps as in Example 1, except that the same LCP powder as in Example 1 and the refined PFA resin obtained above were pressed for 5 minutes at a temperature of 310° C. and a pressing pressure of 6 MPa using the same vacuum high-temperature pressing device as in Example 1.

### Example 3

In Example 3, the LCP fiber mat was formed by a papermaking method using PTFE micro powder (amorphous, average particle size: 0.2 μm, melting point:)327° C. as a filler raw material.

The PTFE micro powder and the same LCP powder as in Example 1 were dispersed in a 50 mass % ethanol aqueous solution as a dispersion medium to form a slurry. The mixing ratio of the PTFE micro powder and the LCP powder was 3:7 in terms of the volume ratio.

Next, a slurry-like mixture was subjected to papermaking using a square sheet machine (manufactured by KUMAGAI RIKI KOGYO Co., Ltd.) on a polyester microfiber nonwoven fabric (basis weight: 14 g/m²) placed on a 80 mesh wire mesh to obtain the LCP fiber mat. The weight of the LCP fiber mat was 2.55 g so that the thickness of the LCP film was 25 μm. Then, the LCP fiber mat was dried with a hot air dryer and transferred onto the same electrolytic copper foil as in Example 1 to form the LCP fiber mat. The FCCL and the LCP film were produced by the same production steps as in Example 1 except that the method for forming the LCP fiber mat was a papermaking method.

### Example 4

In Example 4, uniaxially oriented LCP pellets (cylindrical pellets having a diameter of 3 to 4 mm, melting point: 340° C.) were prepared as the LCP raw material. The material of LCP is a block copolymer of parahydroxybenzoic acid and 4,6-hydroxynaphthoic acid. The LCP powder was produced in the same manner as in Example 1 except that the LCP raw material was changed as described above. The average fiber diameter measured for 100 LCP fibers contained in the LCP powder was 1.4 μm.

The FCCL and the LCP film were produced in the same production steps as in Example 1, except that the same PTFE micro powder as in Example 3 and the LCP powder obtained above were pressed for 10 seconds at a temperature of 310° C. and a pressing pressure of 6 MPa using the same vacuum high-temperature pressing device as in Example 1.

### Example 5

In Example 5, PPE powder (amorphous, average particle size: 4.5 μm, melting point:)290° C. was used as the filler raw material. This was obtained by coarsely pulverizing and finely pulverizing the PPE pellets under the same conditions using the same cutter mill and the liquid nitrogen bead mill used for producing the LCP powder of Example 1. The FCCL and the LCP film were produced by the same production steps as in Example 1 except that the filler raw material was changed to the PPE powder.

### Example 6

In Example 6, the FCCL and the LCP film were produced by the same production steps as in Example 1 except that finely pulverized talc (plate-shaped, average particle diameter: 2.7 μm) was used as the filler raw material.

### Example 7

In Example 7, an LCP powder was produced by the same production steps as in Example 1 except that the ethanol slurry in which the finely pulverized LCP was dispersed was repeatedly pulverized 30 times under the conditions with a nozzle diameter of 0.18 mm and a pressure of 200 MPa using the wet high-pressure crushing device (Star Bar Strabo manufactured by Sugino Machine Limited) to be formed into a fiber. The average fiber diameter measured for 100 LCP fibers contained in the LCP powder was 0.6 μm. As the filler raw material, the same PFA resin as in Example 1 was prepared. Then, the FCCL and the LCP film were produced by the same production method as in Example 3 except that these LCP powder and PFA resin were used, and the LCP fiber mat was pressed together with the release film and the electrolytic copper foil at a temperature of 310° C. and a pressing pressure of 6 MPa for 300 seconds.

### Example 8

In Example 8, an LCP powder was produced by the same production steps as in Example 1 except that the ethanol slurry in which the finely pulverized LCP was dispersed was pulverized once under the conditions with a nozzle diameter of 0.18 mm and a pressure of 200 MPa using the wet high-pressure crushing device (Star Bar Strabo manufactured by Sugino Machine Limited) to be formed into a fiber. The average fiber diameter measured for 100 LCP fibers contained in the LCP powder was 1.7 μm. The FCCL and the LCP film were produced by the same production method as in Example 7 except that this LCP powder was used.

### Example 9

In Example 9, an LCP powder was produced by the same production steps as in Example 1 except that the ethanol slurry in which the finely pulverized LCP was dispersed was repeatedly pulverized 90 times under the conditions with a nozzle diameter of 0.18 mm and a pressure of 200 MPa using the wet high-pressure crushing device (Star Bar Strabo manufactured by Sugino Machine Limited) to be formed into a fiber. The average fiber diameter measured for 100 LCP fibers contained in the LCP powder was 0.07 μm. The FCCL and the LCP film were produced by the same production method as in Example 7 except that this LCP powder was used.

### Example 10

In Example 10, the FCCL and the LCP film were produced by the same production method as in Example 7 except that the mixing ratio of the PFA resin and the LCP powder was 4:6 in terms of the volume ratio.

### Example 11

In Example 11, the FCCL and the LCP film were produced by the same production method as in Example 7 except that the mixing ratio of the PFA resin and the LCP powder was 5:5 in terms of the volume ratio.

### Example 12

In Example 12, the LCP powder produced by the same production steps as in Example 1 was subjected to wet ultraviolet treatment using a low-pressure mercury UV lamp under the conditions with a wavelength of 253.7 nm and treatment time of 2 hours. Note that, X-ray photoelectron spectroscopy (XPS) measurement was performed on the LCP powder before the treatment and the LCP powder after the treatment. The measurement was performed in an energy range of 0 eV to 1200 eV under the conditions that a measurement range was 1000 μm×200 μm and the number of integrations was 2, using “Quantes I” manufactured by ULVAC-PHI Inc. as an XPS measuring device. As a result of this measurement, it was confirmed that an oxygen atom content of the surface of the LCP powder after the treatment was increased with respect to the LCP powder before the treatment. As the filler raw material, the same PFA resin as in Example 1 was prepared. Then, the FCCL and the LCP film were produced by the same production method as in Example 3, except that the ultraviolet-treated LCP powder and the same PFA resin as in Example 1 were used, and the LCP fiber mat was pressed together with the release film and the electrolytic copper foil for 300 seconds at a temperature of 310° C. and a pressing pressure of 6 MPa.

### Example 13

In Example 13, the ethanol slurry was obtained by mixing the same PFA resin as in Example 1 with a 50 mass wt % ethanol aqueous solution. The ethanol slurry was subjected to in-liquid nitrogen plasma discharge treatment 30 times under the conditions that an electrode material was SUS, a voltage was +4 kV, and a nitrogen bubbling amount was 3 L/min. As a result, a plasma-treated PFA resin was obtained. Note that, an XPS measurement was performed for each of the PFA resin before the treatment and the PFA resin after the treatment. The measurement was performed in the same manner as the measurement conditions when the LCP powder was measured in Example 12. As a result of this measurement, it was confirmed that a carboxyl group content on the surface of the PFA resin after the treatment was increased with respect to the PFA resin before the treatment. The FCCL and the LCP film were produced by the same production method as in Example 3, except that this plasma-treated PFA resin and the LCP powder produced by the same production steps as in Example 1 were used, and the LCP fiber mat was pressed together with the release film and the electrolytic copper foil for 300 seconds at a temperature of 310° C. and a pressing pressure of 6 MPa.

### Example 14

In Example 14, the PFA resin refined in the same manner as in Example 2 was mixed with a 50 mass % ethanol aqueous solution to obtain the ethanol slurry. The ethanol slurry was subjected to in-liquid nitrogen plasma treatment 30 times under the conditions that the electrode material was SUS, the voltage was ±4 kV, and the nitrogen bubbling amount was 3 L/min. As a result, a plasma-treated PFA resin was obtained. Note that, the XPS measurement was performed for each of the PFA resin before the treatment and the PFA resin after the treatment under the same conditions as in Example 13. As a result of this measurement, it was confirmed that the carboxyl group content on the surface of the PFA resin after the treatment was increased with respect to the PFA resin before the treatment. The FCCL and the LCP film were produced by the same production method as in Example 3, except that the PFA resin thus treated and the LCP powder obtained by the same production steps as in Example 1 were used, and the LCP fiber mat was pressed together with the release film and the electrolytic copper foil at a temperature of 310° C. and a pressing pressure of 6 MPa for 300 seconds.

### Example 15

In Example 15, the FCCL and the LCP film were produced by the same production method as in Example 3 except that the LCP powder subjected to the wet UV treatment in the same manner as in Example 12 and the PFA resin treated in the same manner as in Example 14 were used, and the LCP fiber mat was pressed together with the release film and the electrolytic copper foil for 300 seconds at a temperature of 310° C. and a pressing pressure of 6 MPa.

### Example 16

In Example 16, after the LCP fiber mat formed on the electrolytic copper foil was heat-pressed in the same manner as in Example 3, the mat was put in an inert gas oven in which the temperature of the atmosphere in the furnace was controlled to 310° C. and the oxygen concentration was controlled to 20 ppm, held for 1 hour and heat-treated to obtain the FCCL containing a heat-treated LCP film. Then, an LCP film was obtained in the same method as in Example 3.

### Example 17

In Example 17, the LCP fiber mat formed on the electrolytic copper foil was heat-pressed in the same manner as in Example 3, and then subjected to light irradiation and heat treatment in this order to obtain the FCCL. Specifically, in the light irradiating step, a light irradiation treatment was performed using a light irradiation device (PulseForge (registered trademark) 1300 manufactured by NovaCentrix). An irradiation voltage was 270 V, a pulse length was 3.5 m, an irradiation surface was on an LCP film side, and the number of times of irradiation was 30 times. In the heat treating step, the FCCL containing the LCP irradiated with light as described above was put into the inert gas oven in which the temperature of the atmosphere in the furnace was controlled to 310° C. and the oxygen concentration was controlled to 20 ppm, and held for 1 hour and heat-treated to obtain the FCCL containing the heat-treated LCP film. Then, an LCP film was obtained in the same method as in Example 3.

### Comparative Example 1

In Comparative Example 1, the FCCL and the LCP film were produced by the same production steps as in Example 1 except that alumina silica (spherical, average particle size: 4 μm) as an inorganic hollow filler was used as the filler raw material.

### Comparative Example 2

In Comparative Example 2, the FCCL and the LCP film were produced by the same production steps as in Example 1, except that the same LCP powder and filler raw material as in Example 1 were used, and pressing was performed for 10 seconds at a temperature of 310° C. and a pressing pressure of 2 MPa using the same high-temperature pressing device as in Example 1.

### Reference Example 1

In Reference Example 1, the FCCL and the LCP film were produced in the same production steps as in Example 3, except that pellets of uniaxially oriented LCP (cylindrical pellets having a diameter of 3 to 4 mm, melting point: 320° C.) were used as the LCP raw material, and only the LCP powder was dispersed in butanediol as the dispersion medium to form a paste in the dispersing step, and a mixture of the LCP powder and the dispersion medium in a paste form was applied onto the roughened surface of the electrolytic copper foil. Therefore, the LCP film according to Reference Example 1 does not contain the filler. Note that, the measured value of D50 of finely pulverized LCP, the yield of the finely pulverized LCP by removing coarse particles, and the average diameter of fiber diameters measured for 100 LCP fibers contained in the LCP powder were the same as those in Example 3 (Example 1).

### Reference Example 2

In Reference Example 2, the LCP fiber mat formed on the electrolytic copper foil was heat-pressed in the same manner as in Reference Example 1, then put into the inert gas oven in which the temperature of the atmosphere in the furnace was controlled to 310° C. and the oxygen concentration was controlled to 20 ppm, and held for 1 hour and heat-treated to obtain the FCCL containing the heat-treated LCP film. Then, the LCP film was obtained in the same method as in Reference Example 1.

### Observation on Liquid Crystal Polymer Film

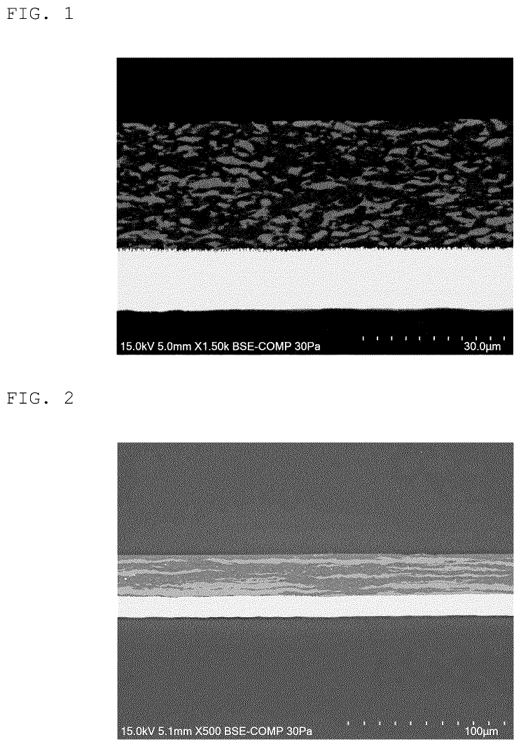

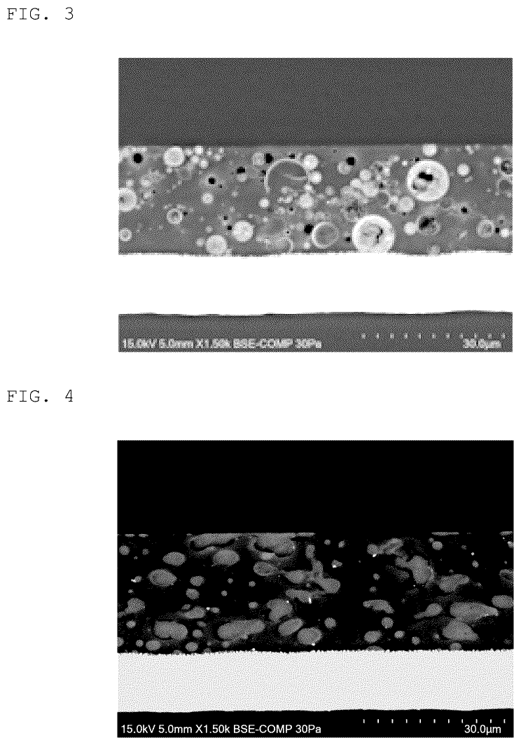

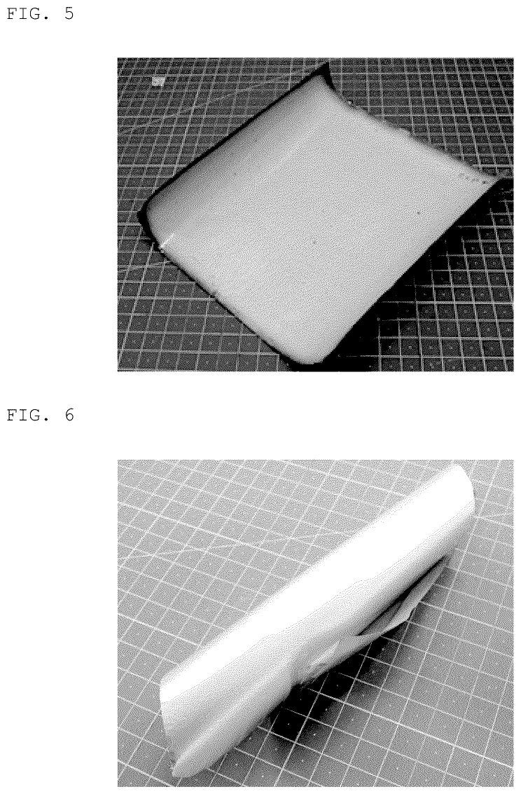

FIGS. 1 to 4 show photographs (SEM images) obtained by photographing sections of LCP films in Example 1, Example 2, Comparative Example 1, and Comparative Example 2. From the photographs of FIGS. 1 to 4, it is found that the LCP films of the examples contain a thin and long flat filler (having a large aspect ratio) and filler aggregates as compared with the LCP film of the comparative examples, and a long diameter of the flat filler is oriented to be substantially parallel to the thickness direction in the LCP film. Moreover, it can be seen that the LCP film of the comparative example contains a large amount of fillers close to a spherical shape rather than a flat shape.

### [Measurement of Average Aspect Ratio and Average Inclination of Filler]

For the LCP films according to each of Examples 1 to 15 and Comparative Examples 1 to 2, the average aspect ratio of the filler and the inclination of the filler with respect to the thickness direction of the LCP film were measured by the measurement method described above. These results are shown in columns of “Average aspect ratio” and “Inclination (°)” in Table 1. An average of 90 fillers in Example 1, 80 in Examples 2 to 6, 90 in Examples 7 to 13, 80 in Example 14, 90 in Example 15, 80 in Comparative Example 1, and 55 in Comparative Example 2 was determined. Note that, a filler having an area smaller than that of a perfect circle having a diameter of 1/100 or less of the thickness of the LCP film is not to be measured, and a filler having an aspect ratio between a major axis and a minor axis of 1.1 or less is regarded as a true sphere, and the aspect ratio is set to 1 and the inclination is set to 45°.

### [Measurement of Linear Expansion Coefficient]

For the LCP films according to each of Examples 1 to 15 and Comparative Examples 1 to 2, the CTE in the main surface was measured. Specifically, the CTE of the LCP film in the main surface (an XY direction) was measured according to JIS K 7197 by a TMA (thermomechanical analysis) method. As conditions of the TMA, a temperature was raised from room temperature to 150° C. under a nitrogen atmosphere, and then the temperature was cooled to room temperature at 10° C./min using a thermal analyzer (TMA4030SA manufactured by Bruker Corporation), a load was set to 10 g, a sample shape was set to a strip shape (5 mm×10 mm), and a CTE between 80° C. and 40° C. in a cooling process was determined. The measurement results of the CTE of the LCP film are shown in the column of “CTE (ppm/° C.)” in Table 1.

### [Measurement of Amount of Warpage]

For the FCCL according to each of Examples 1 to 15 and Comparative Examples 1 to 2, the amount of warpage was measured. Specifically, the FCCL having a 150 mm square was left standing in a glass plate shape with a copper foil surface facing down, a distance from the glass plate was measured for the FCCL square, and an average value thereof was taken as the amount of warpage. The measurement results of the amount of warpage of the FCCL are shown in the column of “Amount of warpage (mm)” in Table 1. Note that, the FCCL becomes cylindrical as the warpage increases, and the distance from the glass plate cannot be measured for a square. In a case where a cylinder having a circumference of 150 mm was formed, the distance of the square from the glass plate was a maximum value (about 48 mm), and thus a cylindrical shape was set to “48 mm or more”.

### [Measurement of MIT Folding Endurance Count]

The MIT folding endurance test was performed on the LCP films according to each of Examples 1 to 3 and 12 to 15. Specifically, first, a part of the LCP film was cut off to obtain a strip-shaped test piece having a width of 1 cm and a length of 10 cm. This test piece was measured for the number of reciprocating folding (MIT folding endurance) until breaking under the conditions with a load of 500 g, a curvature radius of a folding clamp of 0.2 mm, a folding angle of 135 degrees, and a folding speed of 175 cpm using an MIT folding endurance tester. The measurement results of the MIT folding endurance times are shown in Table 2.

### [Measurement of Breaking Strength and Breaking Elongation]

For the LCP films according to each of Examples 3, 16 and 17 and Reference Examples 1 and 2, the breaking strength and the breaking elongation were measured by a tensile test. Specifically, first, a part of the LCP film was cut off to obtain a strip-shaped test piece having a width of 5 mm and a length of 30 mm. The test piece was pulled under a nitrogen atmosphere at a gap width of 13 mm, a speed of 0.01 mm/s, and a temperature of 25° C. using a tensile tester (“RSA-G2” manufactured by TA Instruments) , and a load was measured until the test piece was broken to measure the breaking strength and breaking elongation. The measurement results of the breaking strength and the breaking elongation are shown in Tables 3 and 4.

### [Measurement of First Melting Point (Tm1) and Second Melting Point (Tm2)]

The first melting point (Tm1) and the second melting point (Tm2) of LCP in each of the LCP films according to each of Examples 3, 16 and 17 and Reference Examples 1 and 2 were measured by performing differential scanning calorimetry (DSC) . First, the LCP film was heated from room temperature to 370° C. at a rate of 20° C./min to be totally melted, and the temperature at the endothermic peak appearing at that time was defined as the first melting point (Tm1) of LCP in the LCP film. At this time, in a case where the plurality of endothermic peaks was observed, the highest temperature among the respective temperatures at the plurality of endothermic peaks was defined as the first melting point (Tm1) of LCP in the LCP film. Thereafter, the melt of the LCP film was cooled to 175° C. at a rate of 20° C./min, and the temperature at the endothermic peak appearing when the temperature was raised again to 370° C. at a rate of 20° C./min was taken as the second melting point (Tm2) of LCP in the LCP film. At this time, in a case where the plurality of endothermic peaks was observed, the highest temperature among the respective temperatures at the plurality of endothermic peaks was defined as the second melting point (Tm2) of LCP in the LCP film. The measurement results of the first melting point (Tm1) and the second melting point (Tm2) of each LCP film and the value of a temperature difference (ΔTm=Tm2−Tm1) calculated by subtracting the first melting point (Tm1) from the second melting point (Tm2) are shown in Tables 3 and 4.

### [Wide-Angle X-Ray Scattering Measurement]

A wide-angle X-ray scattering measurement (WAXS) was performed on the LCP films according to each of Reference Examples 1 and 2. The wide-angle X-ray scattering measurement was performed by a transmission method with the LCP film attached to a measurement cell. In a scattering intensity profile obtained by the above measurement, the values of the scattering intensity at a diffraction angle of 21.2 degrees at which scattering derived from an orthorhombic (200) plane is observed are shown in Table 4. Note that, the values of the scattering intensity shown in Table 4 were values (that is, values when a maximum scattering intensity in the scattering intensity profile is 1) when normalized at the peak with the largest scattering intensity in the scattering intensity profile.

TABLE 1

| | LCP powder | | Filler raw material | | | Heat pressing |
|---|---|---|---|---|---|---|
| | Average | | Particle | Melting | Filler | conditions |
| | diameter | UV | size | point | plasma | Temperature |
| | (μm) | treatment | (μm) | (° C.) | treatment | (° C.) |
| Example 1 | 0.8 | Absence | 2 | 300 | Absence | 295 |
| Example 2 | 0.8 | Absence | 2 | 300 | Absence | 310 |
| Example 3 | 0.8 | Absence | 0.2 | 327 | Absence | 295 |
| Example 4 | 1.4 | Absence | 0.2 | 327 | Absence | 310 |
| Example 5 | 0.8 | Absence | 4.5 | 290 | Absence | 295 |
| Example 6 | 0.8 | Absence | 2.7 | — | Absence | 295 |
| Example 7 | 0.6 | Absence | 2 | 300 | Absence | 310 |
| Example 8 | 1.7 | Absence | 2 | 300 | Absence | 310 |
| Example 9 | 0.07 | Absence | 2 | 300 | Absence | 310 |
| Example 10 | 0.6 | Absence | 2 | 300 | Absence | 310 |
| Example 11 | 0.6 | Absence | 2 | 300 | Absence | 310 |
| Example 12 | 0.8 | Presence | 2 | 300 | Absence | 310 |
| Example 13 | 0.8 | Absence | 2 | 300 | Presence | 310 |
| Example 14 | 0.8 | Absence | 2 | 300 | Presence | 310 |
| Example 15 | 0.8 | Presence | 2 | 300 | Presence | 310 |
| Comparative | 0.8 | Absence | 4 | — | Absence | 295 |
| Example 1 | | | | | | |
| Comparative | 0.8 | Absence | 2 | 300 | Absence | 310 |
| Example 2 | | | | | | |

| | | | Evaluation | | | |
|---|---|---|---|---|---|---|
| | Heat pressing conditions | | Average | | CTE | Amount of |
| | Pressure | Time | aspect | Inclination | (ppm/ | warpage |
| | (MPa) | (second) | ratio | (°) | ° C.) | (mm) |
| Example 1 | 6 | 10 | 4.9 | 8.4 | 25 | 15 |
| Example 2 | 6 | 300 | 33.0 | 0.9 | 23 | 10 |
| Example 3 | 6 | 10 | 4.2 | 8.2 | 24 | 11 |
| Example 4 | 6 | 10 | 4.0 | 7.9 | 19 | 4 |
| Example 5 | 6 | 10 | 5.6 | 4.2 | 26 | 15 |
| Example 6 | 6 | 10 | 3.5 | 12.3 | 18 | 1 |
| Example 7 | 6 | 300 | 3.3 | 8.4 | 21 | 8 |
| Example 8 | 6 | 300 | 5.4 | 10 | 30 | 25 |
| Example 9 | 6 | 300 | 3.2 | 8.0 | 19 | 5 |
| Example 10 | 6 | 300 | 5.0 | 9.8 | 28 | 17 |
| Example 11 | 6 | 300 | 5.2 | 10.6 | 34 | 21 |
| Example 12 | 6 | 300 | 4.7 | 7.9 | 25 | 16 |
| Example 13 | 6 | 300 | 5.2 | 8.1 | 26 | 16 |
| Example 14 | 6 | 300 | 34.0 | 1.0 | 22 | 9 |
| Example 15 | 6 | 300 | 31.0 | 1.2 | 22 | 10 |
| Comparative | 6 | 10 | 1.0 | 45.0 | 43 | 48 or |
| Example 1 | | | | | | more |
| Comparative | 2 | | 2.1 | 18.2 | 35 | 48 or |
| Example 2 | | | | | | more |

TABLE 2

| | Evaluation |
|---|---|
| | Times of MIT |
| | folding |
| | endurance |
| | (times) |
| Example 1 | 131 |
| Example 2 | 228 |
| Example 3 | 125 |
| Example 12 | 155 |
| Example 13 | 402 |
| Example 14 | 510 |
| Example 15 | 955 |

TABLE 3

| | Breaking | Breaking | | | |
|---|---|---|---|---|---|
| | strength | elongation | Tm1 | Tm2 | ΔTm |
| | (MPa) | (%) | (° C.) | (° C.) | (° C.) |
| Example 3 | 101.2 | 3.2 | 318.0 | 316.2 | 1.8 |
| Example 16 | 192.0 | 11.4 | 343.9 | 319.4 | 24.5 |
| Example 17 | 74.3 | 24.0 | 351.0 | 323.7 | 27.3 |

TABLE 4

| | | | | | | Scattering |
|---|---|---|---|---|---|---|
| | Breaking | Breaking | | | | intensity |
| | strength | elongation | Tm1 | Tm2 | [symbol] Tm | derived from |
| | (MPa) | (%) | (° C.) | (° C.) | (° C.) | (200) plane |
| Reference | 87.6 | 2.7 | 329.6 | 325.5 | 4.1 | 0.3455 |
| Example 1 | | | | | | |
| Reference | 153.7 | 5.9 | 348.4 | 331.8 | 16.6 | 0.3033 |
| Example 2 | | | | | | |

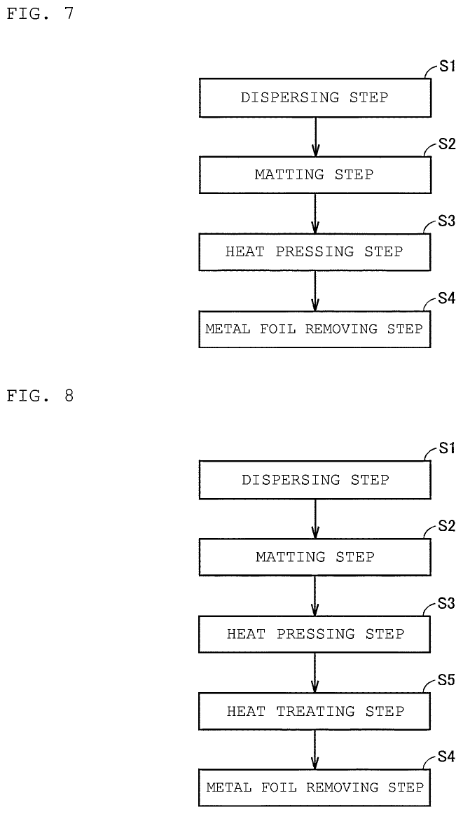

As shown in Table 1, it is found that the CTEs of the LCP film according to Example 1 to 15 in which the average aspect ratio of the filler is 3 to the inclination of the filler with respect to the thickness direction of the LCP film is 15° or less are lower than those of Comparative Examples 1 to 2. Moreover, it can be seen that the amount of warpage of the FCCL decreases in proportion to a CTE value. This can also be confirmed from the FCCL photographs of Example 1 in FIG. 5 and Comparative Example 1 in FIG. 6. Note that, in Example 6, the inorganic filler was used as the filler raw material, and the CTE and the amount of warpage were the lowest as compared with the other examples, but the flexibility was inferior as compared with the other examples, and it can be said that the LCP films of Examples 1 to 5 using the organic filler rich in flexibility is suitable as an FPC substrate (a flexible circuit board).

Furthermore, as shown in Table 1, it is found that in Examples 7 and 9 produced using the LCP in which the average diameter of the fibrous particles composed of LCP is 0.07 μm to 1.4 μm, the amount of warpage of the CTE and the FCCL in the plane of the LCP film is reduced as compared with Example 8 in which the average diameter is 1.7 μm. If the average fiber diameter of the fibrous LCP powder is 0.07 μm to 1.4 μm, the average fiber diameter of the LCP powder is relatively small, so that the fibrous LCP powders are less likely to get on each other. As a result, this is considered to facilitate in-plane orientation of the LCP during production of the LCP film, thereby decreasing the amount of warpage of the CTE and FCCL in the plane of the LCP film.

Furthermore, as shown in Tables 1 and 2, it is found that the LCP film according to Example 12 obtained using the LCP powder whose surface is treated with ultraviolet light has an increased MIT folding endurance and improved strength as compared with the LCP films according to Examples 1 and 3. It can be seen that the LCP film according to Example 13 obtained using the filler whose surface is subjected to the plasma treatment has an increased MIT folding endurance and improved strength as compared with Examples 1 and 3. It can be seen that the LCP film according to Example 14 obtained using the filler whose surface is subjected to the plasma treatment has an increased MIT folding endurance and improved strength as compared with Example 2. It can be seen that the LCP film according to Example 15 obtained using the LCP powder whose surface is subjected to the ultraviolet treatment and the filler whose surface is subjected to the plasma treatment has further increased MIT folding endurance and further improved strength as compared with Examples 12 to 14. It is considered that by treating the surface of the LCP powder or the filler in advance as described above, interfacial adhesion between the LCP powder and the filler is improved, and a film strength is improved. Furthermore, it is considered that an affinity between these materials is improved and the film strength is further improved by previously treating the surfaces of both the LCP powder and the filler.

Moreover, as shown in Table 3, as compared with the LCP film according to Example 3 in which the heat treatment was not performed during production and the temperature difference (Tm) was less than 10° C., the LCP film according to each of Example 16 and Example 17 in which after the heat pressing step, the film was heat-treated at a temperature lower than the melting point of the liquid crystal polymer by 30° C. or higher than the melting point of the liquid crystal polymer by 10° C., and the temperature difference (Tm) was 10° C. or higher had an improved breaking elongation. For the LCP film according to Example 16, the breaking strength was further improved as compared with the LCP film according to Example 3. It is considered that by the heat treatment as described above, the LCP fibers in the LCP film are sufficiently fused to each other, and furthermore, the crystal structure of LCP in the LCP film is changed, and the molecular chains of LCP are further entangled with each other, so that the mechanical strength of the LCP film is further improved.

Moreover, as shown in Table 3, as compared with the LCP films according to Example 3 and Example 16 in which the light irradiation is not performed, in Example 17, the temperature difference (ΔTm) is further increased, and the breaking elongation is further improved. Therefore, it is considered that by the light irradiation described above, the crystal structure of LCP is changed while the LCP fibers are further fused to each other on the surface of the LCP film, whereby the breaking elongation of the LCP film is further improved.

Note that, as shown in Table 4, as compared with the LCP film according to Reference Example 1 in which the heat treatment was not performed during the production and the temperature difference (Tm) was less than 10° C., the LCP film according to Reference Example 2 in which after the heat pressing step, the film was heat-treated at a temperature lower than the melting point of the liquid crystal polymer by 30° C. to higher than the melting point of the liquid crystal polymer by 10° C. or less, and the temperature difference (Tm) was 10° C. or more had improved breaking strength and breaking elongation. Then, the LCP film according to Reference Example 2 has lower scattering intensity from the orthorhombic (200) plane in the WAXS scattering profile than the LCP film according to Reference Example 1. Therefore, in the LCP film according to Reference Example 2, a crystal layer of LCP in the LCP film is reduced as compared with the LCP film according to Reference Example 1. As described above, it is understood from Reference Example 1 and Reference Example 2 that the crystal structure of LCP in the LCP film is actually changed by the heat treatment under the above conditions, and the molecular chains of LCP are further entangled with each other, so that the breaking strength and the breaking elongation of the LCP film are improved, and as a result, the mechanical strength is improved.

In the description of the above embodiment, combinable configurations may be combined with each other.

The embodiments and examples disclosed herein are all to be considered by way of examples in all respects, but not limiting. The scope of the present invention is specified by the claims, but not the above description, and intended to encompass all modifications within the spirit and scope equivalent to the claims.

1. A liquid crystal polymer film comprising:
a liquid crystal polymer; and
a filler, wherein
the filler includes a flat filler,
an average aspect ratio of the filler is 3 or more, and
an average inclination of the filler with respect to a main surface direction of the liquid crystal polymer film is 15° or less.

2. The liquid crystal polymer film according to claim 1, wherein a content ratio of the filler to a total content of the liquid crystal polymer and the filler is 30 vol % to 50 vol %.

3. The liquid crystal polymer film according to claim 1, wherein MIT folding endurance of the liquid crystal polymer film is 130 times or more.

4. The liquid crystal polymer film according to claim 1, wherein the filler is an organic filler.

5. The liquid crystal polymer film according to claim 4, wherein the filler is selected from a perfluoroalkoxy fluorine resin, polytetrafluoroethylene, polyphenylene ether, polyimide, polyamideimide, polyetherimide, polyethersulfone, cyclic polyolefin, syndiotactic polystyrene, and polyphenylene sulfide.

6. The liquid crystal polymer film according to claim 1, wherein the filler is an inorganic filler.

7. The liquid crystal polymer film according to claim 6, wherein the filler is selected from a powder of an inorganic oxide, carbon powder, ceramic powder, and glass powder.

8. A method for producing the liquid crystal polymer film, the method comprising:
dispersing a liquid crystal polymer powder and a filler that includes a flat filler in a dispersion medium to obtain a mixture;
drying the mixture to form a mixture mat; and
heat-pressing the mixture mat to obtain a liquid crystal polymer film wherein an average aspect ratio of the filler is 3 or more, and an average inclination of the filler with respect to a main surface direction of the liquid crystal polymer film is 15° or less.

9. The method for producing a liquid crystal polymer film according to claim 8, wherein the liquid crystal polymer powder contains fibrous particles made of a liquid crystal polymer.

10. The method for producing a liquid crystal polymer film according to claim 9, wherein the fibrous particles made of a liquid crystal polymer have an average diameter of 0.07 μm to 1.4 μm.

11. The method for producing a liquid crystal polymer film according to claim 8, wherein the filler has an average particle size of 1 μm or less.

12. The method for producing a liquid crystal polymer film according to claim 8, wherein an average particle diameter of the filler is more than 1 μm, and a heating temperature of the heat-pressing is in a range of ±10° C. of a melting point of the filler.

13. The method for producing a liquid crystal polymer film according to claim 8, wherein the mixture mat is heat-pressed together with a copper foil.

14. The method for producing a liquid crystal polymer film according to claim 8, further comprising applying the mixture in a paste form to a copper foil before the drying of the mixture.

15. The method for producing a liquid crystal polymer film according to claim 8, wherein the mixture in a slurry form is used to form the mixture mat by a papermaking method.

16. The method for producing a liquid crystal polymer film according to claim 8, Further comprising treating a surface of the liquid crystal polymer powder with ultraviolet rays.

17. The method for producing a liquid crystal polymer film according to claim 8, further comprising plasma-treating a surface of the filler.

18. The method for producing a liquid crystal polymer film according to claim 8, further comprising:
treating a surface of the liquid crystal polymer powder with ultraviolet rays; and
plasma-treating a surface of the filler.

19. The method for producing a liquid crystal polymer film according to claim 8, further comprising, after the heat-pressing, heat-treating the liquid crystal polymer film at a temperature that is 30° C. lower than a melting point of the liquid crystal polymer powder and 10° C. higher than the melting point of the liquid crystal polymer powder.

20. The method for producing a liquid crystal polymer film according to claim 8, further comprising irradiating the liquid crystal polymer film with light after the heat-pressing.
